(19) United States
(12) Patent Application Publication
(10) Pub. No.: US 2007/0242593 A1
(43) Pub. Date: Oct. 18, 2007

(54) Method and device for reading information from optical disc

(75) Inventor: Willem Marie Julia Marcel Coene, Eindhoven (NL)

Correspondence Address: Corporate Patent Counsel;Philips Electronics North america Corporate, P O Box 3001, Briarcliff Manor, NY, 10510, US

(73) Assignee: KONINKLIJKE PHILIPS ELECTRONICS N.V., EINDHOVEN (NL)

(21) Appl. No.: 10/578,070

(22) PCT Filed: Nov. 3, 2004
(86) PCT No.: PCT/IB04/52272

§ 371 Date: May 2, 2006

(30) Foreign Application Priority Data
Nov. 5, 2003 (EP) 03104080.1

(51) Int. Cl. G11B 7/00

(52) U.S. Cl. 369/124.02

(57) ABSTRACT

A method is disclosed for reading information from an optical disc (2) containing tracks (11, 21) with 2D-SCIPER coded information. The method comprises the steps of: generating at least one light beam (32); focussing the light beam (32) in a focal spot (F) on an information layer of the optical disc (2); controlling the radial position of the focal spot (F) such that the focal spot (F) covers pits (10; 20) of two adjacent tracks (11; 21). The optical centre (42) of the focal spot (F) follows a trajectory (45) which is radially offset with respect to a halfway line (44) at a position exactly halfway between the said two adjacent tracks (11; 21). According to this method, the disturbing non-linear intersymbol interference is removed from the multi-level eye-pattern of 2D-SCIPER, yielding much better distinguishable signal levels.

### FIELD OF THE INVENTION

The present invention relates in general to a disc drive apparatus for reading information from an optical storage disc; hereinafter, such disc drive apparatus will also be indicated as “optical disc drive”.

### BACKGROUND OF THE INVENTION

As is commonly known, an optical storage disc comprises at least one track, either in the form of a continuous spiral or in the form of multiple concentric circles, of storage space where information may be stored in the form of a data pattern that consists of physical marks and the absence of those marks for both bit-types in the case of binary modulation. Optical discs may be read-only type, where information is recorded during manufacturing, which information can only be read by a user. The optical storage disc may also be a writable type, where information may also be stored by a user. For writing information in the storage space of the optical storage disc, or for reading information from the disc, an optical disc drive comprises, on the one hand, rotating means for receiving and rotating an optical disc, and on the other hand optical means for generating an optical beam, typically a laser beam, and for scanning the storage track with said laser beam. Since the technology of optical discs in general, the way in which information can be stored in an optical disc, and the way in which optical data can be read from an optical disc, is commonly known, it is not necessary here to describe this technology in more detail.

A data pattern representing the information stored on the optical disc is typically a pattern of oblong pits, the pits being arranged successively, defining a track. This track results from the sequential writing mechanism when writing an optical disc. The pit-marks and the non-marks consist of an integer multiple of a basic length which is called the channel bit-length T. In conventional optical storage, the information is encoded in the lengths of successive marks and non-marks measured in units of T. This is the well-known domain of runlength-limited coding (RLL) with the EFM code for CD and the EFMPlus code for DVD.

Conventionally, information was coded by setting the length of the pits and/or the distance between adjacent pits. As a consequence, the location of pits would vary depending on the information content. In a more recent development, pits are arranged at fixed locations, and information is coded by setting the positions of the front edge and rear edge with respect to a fixed nominal centre of the corresponding pit. Such coding system is indicated as Single Carrier Independent Pit Edge Recording (SCIPER). A more elaborate description of this system is given in U.S. Pat. No. 6,392,973.

For optically scanning the rotating disc, an optical disc drive comprises a light beam generator device (typically a laser diode), an objective lens for focussing the light beam in a focal spot on the disc, and an optical detector for receiving the light reflected from the disc and for generating an electrical detector output signal. The intensity of the reflected light as received by the detector depends on the interference of the incident light by the pit-structures on the disc; such interference can for instance be destructive so that less light is being reflected leading to a smaller detected signal on the photo-detector; thus, intensity variations of the reflected light, translated into electrical signal intensity variations by the optical detector, correspond to pit edge positions and hence to the information recorded on the disc.

As mentioned in said publication U.S. Pat. No. 6,392,973 (see for instance FIG. 9A of said publication), the focal spot may be aligned with a track, so that light intensity variations are caused by pits of one track only. However, it is also possible that the focal spot is positioned to cover two adjacent tracks (see for instance FIG. 9B and FIG. 9C of said publication), so that light intensity variations are caused by pits of two adjacent tracks.

In the system described in said publication U.S. Pat. No. 6,392,973, the pits are arranged according to a rectangular layout, i.e. pits of adjacent tracks are arranged next to each other. In an even more recent development, a pit layout has been proposed where the pits are arranged according to a hexagonal pattern, i.e. a pit of one track is arranged in between two pits of the adjacent track (see, for instance, F. Yokogawa, INSIC Optical Storage Roadmap, Signal Processing and Gray-Scale Section Report, January 2003). Such system is indicated as 2D-SCIPER.

FIG. 1 schematically illustrates a configuration proposed for the case of physical parameters that relate to the Blu-Ray Disc format. A first row of pits is indicated at 11, a second row of pits is indicated at 21. The first row 11 defines a first track, and the second row 21 defines a second track. Pits in the first row 11 are indicated as first row pits 10; individual first row pits 10 are distinguished from each other by addition of a letter a, b, c, etc. Similarly, pits in the second row 21 are indicated as second row pits 20, and individual second row pits 20 are distinguished from each other by addition of a letter a, b, c, etc. Each pit 10, 20 has a predefined, fixed nominal centre or central point 12, 22. The central points of all first row pits 10 define a first track centre line 13; the central points of all second row pits 20 define a second track centre line 23. The distance between the track centre lines 13 and 23 of two adjacent tracks 11 and 21 is indicated as track pitch TP. In the proposed configuration, related to physical parameters for Blu-ray Disc (with numerical aperture NA=0.85 and a blue laser with wavelength of 405 nm), the track pitch TP is approximately 205 nm.

Each pit 10, 20 has width PW, measured perpendicularly to the corresponding track centre line 13, 23. In the proposed configuration, the pit width PW is in the range of approximately 80-100 nm (for the physical parameters related to Blu-ray Disc).

The central points of successive pits 10 of one track 11 are displaced with respect to the central points of successive pits 20 of the adjacent track 21, such that a radial projection of a central point of a pit 10 onto the adjacent track 21 corresponds to a position substantially exactly halfway between the two central points of two successive pits 20 of said adjacent track 21. Thus, the central points of the pits 10, 20 together define a hexagonal lattice.

The distance between the central points of successive pits 10, 20 of one track 11, 21, i.e. measured in the tangential direction or track direction, is indicated as pit pitch PP. In the proposed configuration, the pit pitch PP is approximately 237 nm. In order to take into account that consecutive tracks do not have the same length (the length difference being 2π-TP), the pit pitch PP is slightly increased from one track to the next in order to maintain the hexagonal arrangement. When the pit pitch is increased to such extent that the track can contain one or more additional pits at the original pit pitch, a new “zone” in the format can be initiated, hereby maintaining the local density also at larger radii of the disc. Thus, the disc contains a plurality of radial zones, the number of pits in each track differing from zone to zone.

Each pit has a first edge 14 and a second edge 15, as illustrated for pit 10a. The distance between the first edge 14 and the corresponding centre point 12 of the corresponding pit 10a is indicated as front distance DF, while the distance between the second edge 15 and the corresponding centre point 12 of the corresponding pit 10a is indicated as rear distance DR. For each edge 14, 15, there are three possible edge positions, so that the front distance DF can take three predefined values; the same applies to the rear distance DR. Particularly, in the proposed configuration, the front distance DF can take the values 44.5 nm, 59.5 nm, 74.5 nm; the same applies to the rear distance DR. Thus, each pit edge 14, 15 defines a coded ternary symbol, i.e. a symbol which can take three values, which will hereinafter be indicated as 0, 1, 2.

The tracks 11, 21 are scanned with an optical beam having a wavelength of about 405 nm (like in the BD system), the beam being focussed to a substantially circular spot 40 having a spot diameter SD. The scan direction is indicated by arrow V in FIG. 1. The optical beam is directed such that the spot 40 covers two adjacent tracks 11, 12. FIG. 1 illustrates, that the optical spot 40 covers four symbols simultaneously: the front and rear edges of a pit 10c of one track 11, the rear edge of a pit 20b of the adjacent track 21, and the front edge of a pit 20c of the adjacent track 21. These symbols are indicated as S1, S2, S3, S4, respectively. It should be clear that, if the optical spot is displaced over a distance corresponding to half the pit pitch PP, the optical spot 40 again covers four symbols simultaneously, now the front and read edges of a pit of said adjacent track 21 and the rear edge and the front edge of successive pits of the first track 11.

An advantage of such coding scheme is that very high data densities are possible. However, a difficulty arises in the process of decoding the read signal received from the optical detector. Since the optical spot covers four symbols simultaneously, while each symbol can take three values, there are 81 possibilities of combination. For the amount of light reflected from the optical spot 40, it makes a difference whether, for instance, symbol S1=2 while all other symbols are zero, or, for instance, symbol S3=2 while all other symbols are zero, or whether S1=S2=1 and S3=S4=0, or whether S3=S4=1 and S1=S2=0. More particularly, when scanning such four-symbol configuration, there are 81 possibilities for the output signal to be expected, as illustrated by FIG. 2. However, the signal waveform that is obtained for the integrated symbol value S1+S2+S3+S4 (being 2 in the above example) should reflect only 9 different signal levels (since S1+S2+S3+S4 can range from 0 to 8). FIG. 2 is a graph containing all 81 possibilities for the output signal; such graph is indicated as a multi-level “eye-pattern”. The eye-pattern of FIG. 2 illustrates that distinguishing between the 81 signal possibilities is very difficult. This can be seen as the fuzzy clustering of levels to the 9 basic levels referred to above: this can be explained as systematic amplitude jitter on the signal levels that is induced by the asymmetry of the different cases that would need to lead to the same signal level since the integrated symbol value S1+S2+S3+S4 is identical for these cases. Thus, the chances on decoding errors are relatively high.

It is an objective of the present invention to provide a method for reading 2D-SCIPER coded information which reduces the chances on decoding errors.

More particularly, it is an objective of the present invention to provide a method for reading 2D-SCIPER coded information such that the eye-pattern of possible read signals shows improved, clearly distinguishable levels.

### SUMMARY OF THE INVENTION

According to an important aspect of the present invention, the centre of the optical spot is radially offset with respect to a position exactly halfway two adjacent tracks. In a preferred embodiment, two optical spots are used, one being offset on one direction, the other being offset in the opposite direction, the magnitude of both offsets preferably being substantially equal.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 schematically illustrates a 2D-SCIPER configuration;

FIG. 2 is a graph illustrating the eye-pattern for the 2D-SCIPER configuration of FIG. 1, for the normal case where the centre of the optical spot follows a trajectory located exactly halfway two adjacent tracks;

FIG. 3 schematically illustrates an optical disc drive apparatus;

FIG. 4 schematically illustrates track following details in accordance with prior art;

FIG. 5 schematically illustrates track following details in accordance with the present invention;

FIG. 6 is a graph illustrating the eye-pattern resulting in accordance with the present invention;

FIG. 7 schematically illustrates track following details in accordance to a preferred embodiment of the present invention.

FIG. 8 schematically illustrates a 2D-SCIPER configuration in accordance with the present invention; and

FIG. 9 schematically illustrates a system for deteching optical read signals and for processing the optical read signals.

### DESCRIPTION OF THE INVENTION

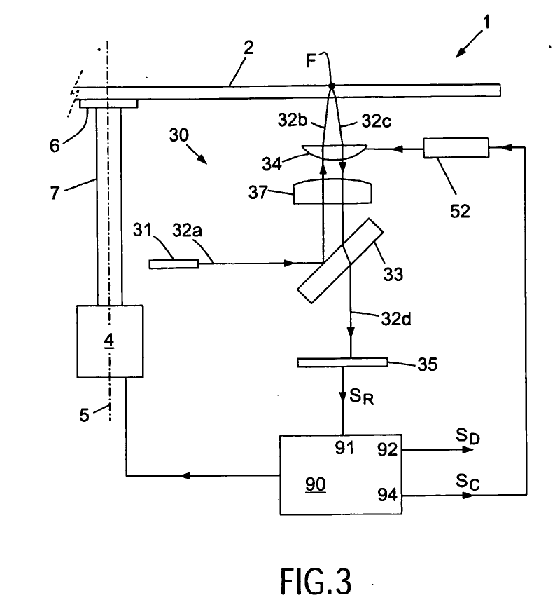

FIG. 3 schematically illustrates an optical disc drive apparatus 1, suitable for reading information from an optical storage disc 2 containing 2D-SCIPER coded information. The optical disc 2 comprises at least one track (not shown in FIG. 3 for sake of simplicity), either in the form of a continuous spiral or in the form of multiple concentric circles, of storage space where information is stored in the form of a 2D-SCIPER data pattern. Defining a pit parameter as the number of data pits per 360° track revolution, the disc 2 typically comprises a plurality of radial zones, all tracks within one zone having the same pit parameter, and the tracks in adjacent zones having different pit parameters.

For rotating the disc 2, the disc drive apparatus 1 comprises a motor 4 fixed to a frame (not shown for sake of simplicity), defining a rotation axis 5. For receiving and holding the disc 2, the disc drive apparatus 1 may comprise a turntable or clamping hub 6, which in the case of a spindle motor 4 is mounted on the spindle axle 7 of the motor 4.

The disc drive apparatus 1 further comprises an optical system 30 for scanning tracks of the disc 2 with an optical beam. The optical system 30 comprises a light beam generating means 31, typically a laser such as a laser diode, arranged to generate a light beam 32. In the following, different sections of the optical path of light beam 32 will be indicated by a character a, b, c, etc added to the reference numeral 32.

The light beam 32 passes a beam splitter 33, a collimator lens 37 and an objective lens 34 to reach (beam 32b) the disc 2. The objective lens 34 is designed to focus the light beam 32b in a focal spot F on an information layer (not shown for sake of simplicity) of the disc 2. The light beam 32b reflects from the disc 2 (reflected light beam 32c) and passes the objective lens 34, the collimator lens 37 and the beam splitter 33 (beam 32d) to reach an optical detector 35.

During operation, the light beam should remain focussed and should follow the tracks. To this end, the objective lens 34 is arranged displaceable in axial and radial directions, and the optical disc drive apparatus 1 comprises an actuator system 52 arranged for displacing the objective lens 34 with respect to the disc 2. Since actuator systems are known per se, while further the design and operation of such actuator system is no subject of the present invention, it is not necessary here to discuss the design and operation of such actuator system in great detail.

It is noted that means for supporting the objective lens with respect to an apparatus frame, and means for displacing the objective lens, are generally known per se. Since the design and operation of such supporting and displacing means are no subject of the present invention, it is not necessary here to discuss their design and operation in great detail.

The disc drive apparatus 1 further comprises a signal processing circuit 90 having a read signal input 91 for receiving a read signal S_{R} from the optical detector system 35. The signal processing circuit 90 is designed to process the read signal S_{R} in order to derive a data signal S_{D} and to provide this data signal S_{D} at a data output 92. The signal processing circuit 90 is further designed to process the read signal S_{R} in order to generate control signals S_{C} for the actuator system 52, and to provide these control signals S_{C} at a control output 94.

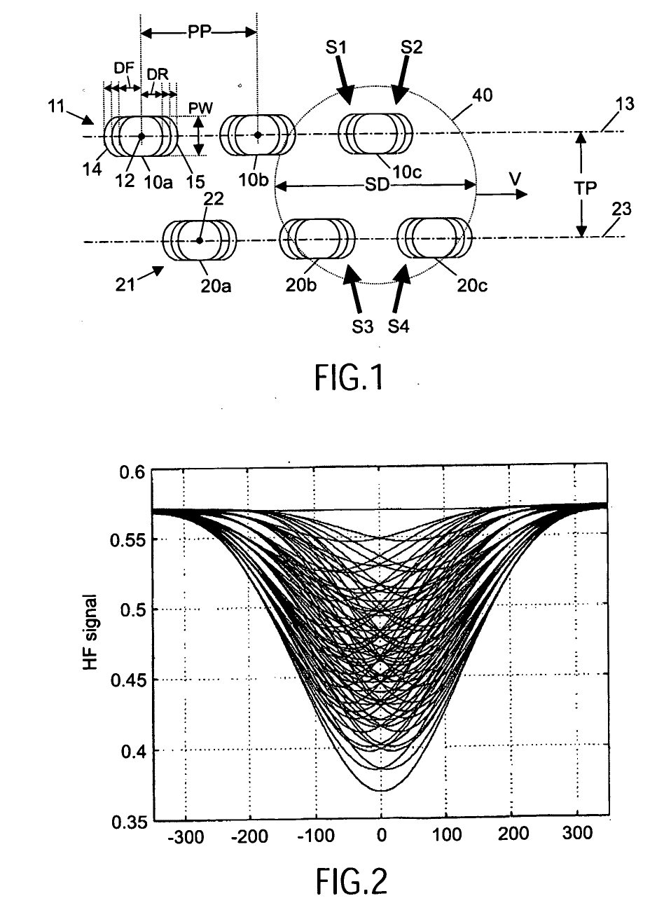

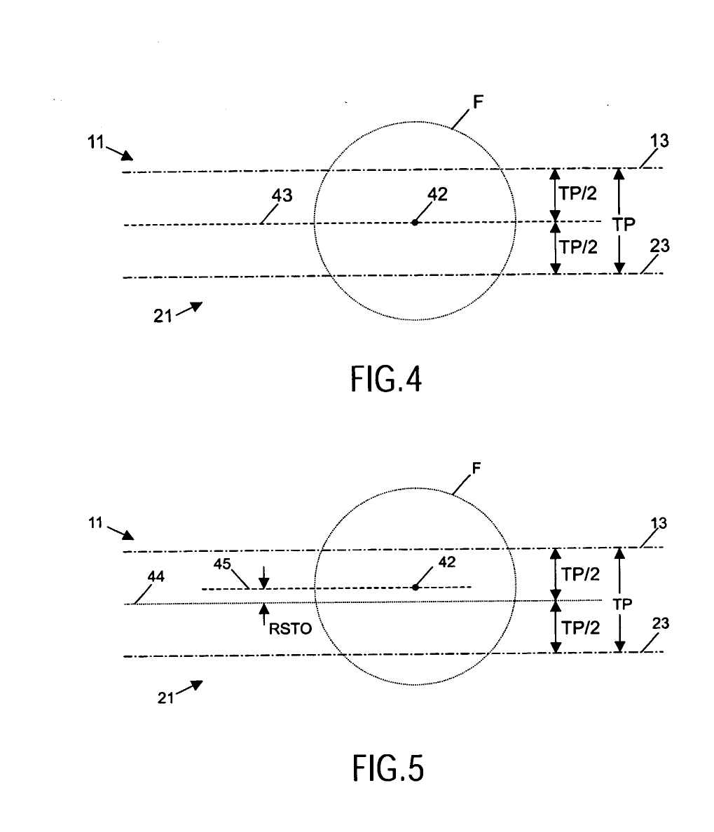

FIG. 4 schematically illustrates track following details in more detail as compared to FIG. 1, for the prior art situation. In FIG. 1, the centre of the optical spot F is indicated at 42. A broken line 43 indicates the spot trajectory, i.e. the path followed by the optical spot centre 42; in accordance with prior art, the spot trajectory 43 is located exactly halfway between the centre lines 13 and 23 of two adjacent tracks 11 and 21. With such spot trajectory, the eye-pattern of FIG. 2 results.

FIG. 5 is a drawing comparable to FIG. 4, but now showing track following details in accordance with the present invention. Dotted line 44 is a line which is located exactly halfway between the centre lines 13 and 23 of two adjacent tracks 11 and 21; in the following, this line will be indicated as halfway line 44. It is noted that in prior art the spot trajectory coincides with the halfway line 44 (see FIG. 4). A broken line 45 indicates the spot trajectory in accordance with the present invention. It is clearly shown that the spot trajectory is radially displaced (offset) with respect to the halfway line 44. The radial offset of the spot trajectory 45 is indicated as RSTO. A very suitable value for RSTO, which appears to be optimal and which is, therefore, preferred, is RSTO=0.1·TP (for the considered (quasi) hexagonal arrangement of pits, the track pitch TP corresponds to 0.5·√3·PP). This value applies for the chosen parameters of the 2D SCIPER storage system (relative to the scaled distances with scaling factor λ/(2NA), with λ being the wavelength of the laser light. If the (relative) storage density changes, also the optimum value of the radial displacement RSTO will change accordingly.

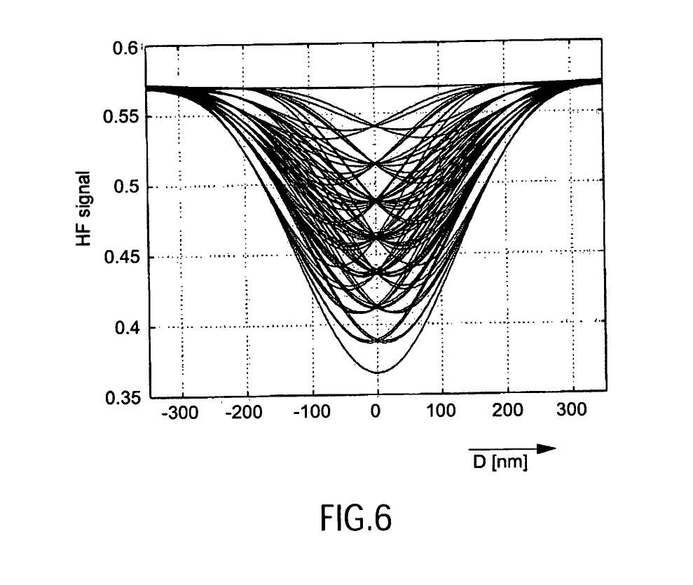

FIG. 6 is a graph comparable to FIG. 2, illustrating the eye-pattern which results with a radial spot trajectory offset of 0.1·TP. The horizontal axis represents the distance D, measured parallel to the track direction, between the spot centre 42 and a point of reference. This point of reference (D=0) is located halfway between two pits (for instance: between pits 10b and 10c) of the first track 11, i.e. the track towards which the optical spot F is offset. The vertical axis represents signal magnitude, in arbitrary units. It can clearly be seen that, around D=0, which is the ideal sampling phase of this eye-pattern, the signals to be expected can take only one of nine distinct, sharp levels, which are easily distinguishable. Thus, the improvement over the prior art (compare FIG. 2) is clear.

It is noted that FIG. 6 shows the eye-pattern resulting from a combination of four symbols associated with two half-pits of the first track 11 and one pit of the second track 21 (for instance rear edge of pit 10b, front edge of pit 10c, and both edges of pit 20b), ignoring all other pits and pit edges. The situation becomes more complicated if more pits are taken into account. Equalization can reduce the effect of intersymbol interference of pits that are beyond the range of the first neighbours. Nevertheless, FIG. 6 clearly illustrates that a combination of four symbols as mentioned can be decoded more reliably than in prior art, if the centre of the optical spot is displaced as mentioned. This implies that the systematic intersymbol interference which has lead to the fuzzy levels in the eye-pattern of FIG. 2 has been compensated by shifting the radial position of the laser spot.

Again, it is noted that FIG. 6 shows the eye-pattern resulting from a combination of four symbols associated with two half-pits of the first track 11 and one pit of the second track 21 (for instance rear edge of pit 10b, front edge of pit 10c, and both edges of pit 20b). For reading a combination of four symbols associated with two half-pits of the second track 21 and one pit of the first track 11 (for instance the symbols S1, S2, S3, S4 as illustrated in FIG. 1), the situation is opposite. Improving the readout of such combination of four symbols in accordance with the invention is achieved when the optical spot is radially offset in the opposite direction, i.e. towards the second track 21.

In principle, it is possible to implement the present invention with only one optical spot. Then, reading the combination of two tracks 11 and 21 will involve two scan revolutions, one revolution with the optical spot being offset in a direction towards the first track 11, and the second revolution with the optical spot being offset in the opposite direction. For correctly decoding the information recorded in the pits of both tracks, the readout signal of the first revolution should be buffered in a track memory, and should be re-read from this track memory during the second revolution for suitable combination with the readout signal of the second revolution: the signal of the first and second scans are properly multiplexed so that decoding and signal processing can produce the symbol values. Or, the readout signal of both revolutions should be stored for later processing.

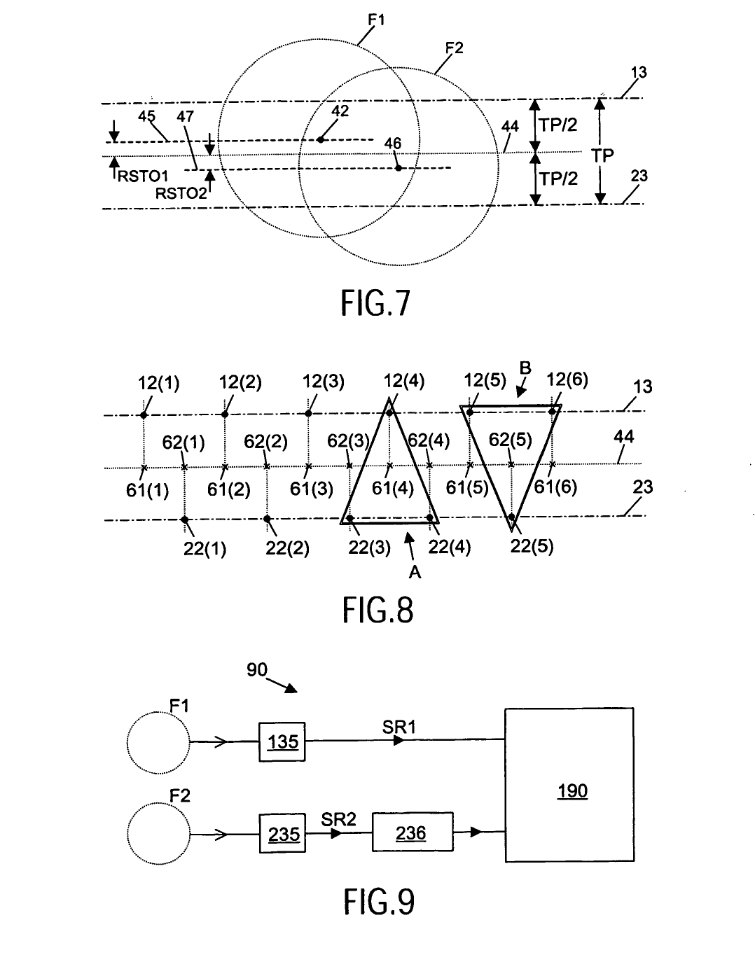

Preferably, however, the present invention is implemented with two optical spots, one optical spot being offset in a direction towards the first track 11, and the second optical spot being offset in the opposite direction, as schematically illustrated in FIG. 7, where two optical spots F1 and F2 are shown, having respective spot centres 42 and 46 substantially displaced from each other in track direction. The optical centre 42 of the first optical spot F1 is radially offset towards the first track 11 (RSTO1), while the optical centre 46 of the second optical spot F2 is radially offset in opposite direction towards the second track 21 (RSTO2), both offsets preferably having equal magnitude (|RSTO1|=|RSTO2|).

In FIG. 7, the tangential distance (i.e. measured along the direction of the track axes 13 and 23) between the two optical centres 42 of the two optical spots F1 and F2, respectively, is shown as being relatively small such that the two optical spots partially overlap. Preferably, said distance is much larger, such that the two optical spots F1 and F2 do not overlap. A suitable distance is, for instance, in the order of about 1 μm, without the invention being restricted to this distance. In fact, the two optical spots F1 and F2 may be generated by two separate laser sources and two separate optical systems located 180° opposite with respect to the disc rotation axis 5. On the other hand, in order to save costs, it is preferred that the two optical spots F1 and F2 are generated by one common laser, for instance by splitting a laser beam using a splitting device such as a diffraction grating. Also, if the mutual beam distance is in the order of 10 μm, these two beams are focussed by one common optical lens system. Since splitting a beam into two or more beams by using a grating is known per se, it is not necessary here to explain this technique in more detail.

In FIG. 7, the track centre lines 13 and 23 are shown as straight lines. Actually, however, the track centre lines 13 and 23 are curved lines, the radius of curvature of these lines being smaller at an inner radius of the disc and larger at an outer radius of the disc. As a consequence, it may be that an ideal orientation of the two optical spots F1 and F2 with respect to each other has to be adapted when going from an inner radius to an outer radius. This can easily be achieved by slightly rotating the splitting device (i.e. diffraction grating). This rotation of the diffraction grating can be controlled by an actuator and related servo-control means.

FIG. 8 is a drawing comparable to FIG. 1, on a smaller scale, showing two track centre lines 13 and 23 and two series of pit centres 12(1), 12(2), 12(3), etc and 22(1), 22(2), 22(3), etc, respectively. These pit centres are projected on the halfway line 44, giving read locations 61(1), 62(1), 61(2), 62(2), etc, read locations 61(i) corresponding to pit centres 12(i) and read locations 62(i) corresponding to pit centres 22(i). It is noted that these read locations define moments in time for sampling the optical read signal SR, which moments will be indicated as sampling moments or sampling phases.

In the case of “normal” 2D-SCIPER with only one optical spot, the sampling phases 61(i) and 62(i) are scanned intermittently. When the optical spot has reached a first sampling phase 61(i), the optical read signal SR contains information from four symbols which are located in an orientation roughly defining a triangle with its top directed towards the first track 11, as illustrated at A. When the optical spot has reached a second sampling phase 62(i), the optical read signal SR contains information from four symbols which are located in an orientation roughly defining a triangle with its top directed towards the second track 21, as illustrated at B.

In the prior art, where the sampling phases are scanned by only one optical spot, the optical read signals SR are obtained by one optical detector 35 in the order 61(1), 62(1), 61(2), 62(2), 61(3), 62(3), etc. In the present invention, the first sampling phases 61(i) are scanned by the second optical spot F2, while the second sampling phases 62(i) are scanned by the first optical spot F1. In order to be able to clearly distinguish optical read signals SR1 obtained by the first optical spot F1 from optical read signals SR2 obtained by the second optical spot F2, the optical system 30 preferably comprises two independent optical detectors 135 and 235, wherein the first optical detector 135 receives the light reflected from the first optical spot F1, and wherein the second optical detector 235 receives the light reflected from the second optical spot F2, as illustrated in FIG. 9.

In view of the tangential distance between the two optical spots F1 and F2, the timing relationship between the readout signals regarding the two sampling phases is shifted. In the illustrated example, the second optical spot F2 is ahead of the first optical spot F1, hence first optical read signals SR1 obtained by the first optical spot F1 lag with respect to the second optical read signals SR2 obtained by the second optical spot F2. In order to eliminate this timing difference, the second optical read signals SR2 may be delayed in a buffer or delay 236 before being processed in a signal processor circuit 190, as illustrated in FIG. 9.

It should be clear to a person skilled in the art that the present invention is not limited to the exemplary embodiments discussed above, but that several variations and modifications are possible within the protective scope of the invention as defined in the appending claims.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for reading information from an optical disc (2), the information being stored according to pit edge recording in pits (10, 20) having nominal pit centres (12) arranged according to a substantially hexagonal pattern, the pit centres (12) defining substantially circular centre lines (13, 23) of tracks (11, 21), the method comprising the steps of:
generating at least one light beam (32);
focussing the light beam (32) in at least one focal spot (F; F1, F2) on an information layer of the optical disc (2);
controlling the radial position of the optical centre (42; 46) of the focal spot (F; F1, F2) to follow a trajectory (45; 47) located between the two centre lines (13, 23) of two adjacent tracks (11; 21), the focal spot (F; F1, F2) having a size such as to cover pits (10; 20) of said two adjacent tracks (11; 21);
wherein the radial distance between said trajectory (45; 47) and a first one (13) of said two centre lines (13, 23) differs from the radial distance between said trajectory (45; 47) and the second one (23) of said two centre lines (13, 23).

2. Method according to claim 1, wherein said trajectory (45; 47) has a radial spot trajectory offset (RSTO; RSTO1, RSTO2) with respect to a halfway line (44) at a position exactly halfway between said two centre lines (13, 23),
the radial spot trajectory offset (RSTO; RSTO1, RSTO2) being approximately equal to 0.1·TP,
TP being the radial distance between said two centre lines (13, 23).

3. Method according to claim 1, further comprising the steps of:
detecting light (32d) reflected from the disc (2);
processing a detector output signal (SR; SR1, SR2) which represents the reflected light in order to decode the detector output signal (SR; SR1, SR2) in order to obtain the information present in said signals.

4. Method according to claim 3, wherein a detector output signal (SR; SR2) is sampled at a first sampling phase (61i) when the optical centre (42; 46) of the focal spot (F; F2) is radially aligned with a pit centre (12) of a first track (11), and wherein a detector output signal (S_{R}; SR1) is sampled at a second sampling phase (62i) when the optical centre (42; 42) of the focal spot (F; F1) is radially aligned with a pit centre (12) of a second track (21);
wherein, at said first sampling phase (61i), the radial distance between the optical centre (42; 46) of the focal spot (F; F2) and said first track (11) is larger than 0.5·TP;
and wherein, at said second sampling phase (62i), the radial distance between the optical centre (42; 42) of the focal spot (F; F1) and said second track (21) is larger than 0.5·TP;
TP being the radial distance between said two centre lines (13, 23).

5. Method according to claim 4, wherein the disc (2) is scanned with only one optical spot (F), wherein, for sampling at the first sampling phases (61i), the radial position of the optical centre (42) of the focal spot (F) is controlled to follow a trajectory (47) closer to said second track (21) during at least one disc revolution, and wherein, for sampling at the second sampling phases (62i), the radial position of the optical centre (42) of the focal spot (F) is controlled to follow a trajectory (46) closer to said first track (11) during at least one disc revolution.

6. Method according to claim 5, further comprising the steps of:
obtaining signal samples from the first sampling phases (61i) during one disc revolution;
storing said signal samples from the first sampling phases (61i);
obtaining signal samples from the second sampling phases (62i) during one disc revolution;
multiplexing said signal samples from the first sampling phases (61i) and said signal samples from the second sampling phases (62i);
processing together the multiplexed signal samples from the first and second sampling phases.

7. Method according to claim 4, wherein the disc (2) is scanned with at least two optical spots (F1, F2), wherein the radial position of the optical centre (42) of a first focal spot (F1) is controlled to follow a first trajectory (45) closer to said first track (11), and wherein the radial position of the optical centre (46) of a second focal spot (F2) is controlled to follow a second trajectory (47) closer to said second track (21);
wherein, for sampling at the first sampling phases (61i), a read signal (SR2) obtained from said second focal spot (F2) is sampled, and wherein, for sampling at the second sampling phases (62i), a read signal (SR1) obtained from said first focal spot (F1) is sampled.

8. Method according to claim 7, wherein the read signal (SR2) of at least one of said focal spots (F2) is buffered or delayed with respect to the other read signal (SR1).

9. Method according to claim 7, wherein said two focal spots (F1, F2) are generated by splitting a single laser beam using a splitting device such as for instance a diffraction grating.

10. Disc drive apparatus (1), for reading information from an optical disc (2), the information being stored according to pit edge recording in pits (10, 20) having nominal pit centres (12) arranged according to a substantially hexagonal pattern, the pit centres (12) defining substantially circular centre lines (13, 23) of tracks (11, 21), the apparatus being designed to perform the method of claim 1.

11. Disc drive apparatus according to claim 10, comprising:
an optical system (30) for generating two focal spots (F1, F2) for scanning tracks (11, 21) of the disc (2);
an actuator (52) for controlling the positioning of the two focal spots (F1, F2);
a controller (90) for controlling the actuator (52);
wherein the controller (90) is designed to control the actuator (52) such that the optical centre (42) of a first focal spot (F1) follows a first trajectory (45) between the two centre lines (13, 23) of adjacent tracks (11; 21), the first trajectory (45) being closer to a first one (11) of said tracks (11, 21) while the optical centre (46) of a second focal spot (F2) follows a second trajectory (47) between said two centre lines (13, 23), the second trajectory (47) being closer to the other one (21) of said tracks (11, 21).

12. Disc drive apparatus according to claim 11, further comprising:
a first optical detector (135) for receiving reflected light from said first focal spot (F1), and for generating a first read signal (SR1);
a second optical detector (235) for receiving reflected light from said second focal spot (F2), and for generating a second read signal (SR2);
delay means (236) for delaying the second read signal (SR2) with respect to the first read signal (SR1);
processing means (190) for processing the first read signal (SR1) together with the delayed second read signal (SR2).

13. Disc drive apparatus according to claim 11, wherein said optical system (30) comprises a laser source generating a common laser beam, and a beam splitting device such as for instance a diffraction grating arranged for splitting the common laser beam in at least two separate beams.

14. Disc drive apparatus according to claim 13, wherein said beam splitting device is adjustable for adjusting the positioning of the two focal spots (F1, F2).

15. Disc drive apparatus according to claim 11, wherein the radial offset (RSTO1) between said first trajectory (45) and a halfway line (44) at a position exactly halfway between the said two adjacent tracks (11; 21) is smaller than TP/2, TP being the radial distance between said two centre lines (13, 23);
and wherein the radial offset (RSTO2) between said second trajectory (47) and said halfway line (44) is smaller than TP/2;
said offsets preferably being approximately equal to 0.1·TP.
